(19) United States
(12) Patent Application Publication
(10) Pub. No.: US 2020/0243818 A1
(43) Pub. Date: Jul. 30, 2020

(54) POWER STORAGE MODULE

(71) Applicant: HONDA MOTOR CO., LTD., Tokyo (JP)

(72) Inventor: Atsushi Sakurai, Wako-shi (JP)

(21) Appl. No.: 16/740,510

(22) Filed: Jan. 13, 2020

(30) Foreign Application Priority Data
Jan. 25, 2019 (JP) 2019-011535

(51) Int. Cl. H01M 2/10; H01M 10/647; H01M 10/6551; H01M 10/613

(52) U.S. Cl. CPC H01M 2/1077; H01M 10/647; H01M 2/1022; H01M 10/613; H01M 10/6551

(57) ABSTRACT

A power storage module includes: a plurality of battery cells that are stacked in one direction; and a battery case that houses the plurality of battery cells.

The battery case includes: a case main body which is formed in a tubular shape having an axial direction that is a first orthogonal direction orthogonal to a stacking direction of the plurality of battery cells, and of which an inside is a housing space that houses the plurality of battery cells; and a plurality of partition walls which are connected to an inner surface of the case main body, which are arranged to be spaced from each other in the stacking direction, and which partition the housing space into a plurality of division spaces that are arranged in the stacking direction. Lengths of the division spaces in the stacking direction become smaller toward a middle from an end of the housing space in the stacking direction.

### CROSS-REFERENCE TO RELATED APPLICATION

Priority is claimed on Japanese Patent Application No. 2019-011535, filed on Jan. 25, 2019, the contents of which are incorporated herein by reference.

### BACKGROUND

### Field of the Invention

The present invention relates to a power storage module.

### Background

Published Japanese Translation No. 2018-521447 of the PCT International Publication discloses a power storage module (battery) in which a battery cell group obtained by stacking a plurality of battery cells is housed in a protection casing. Specifically, in the power storage module disclosed in Published Japanese Translation No. 2018-521447 of the PCT International Publication, each of a plurality of battery cell groups is housed in each of a plurality of internal pockets of the protection casing arranged in a stacking direction of the battery cells. Partition walls of the protection casing that define the internal pocket are positioned between battery cell groups that are adjacent in the stacking direction of the battery cells.

### SUMMARY

In a power storage module that includes a plurality of battery cells stacked in one direction, each of the battery cells generates heat in association with charging and discharging. However, heat generated in a battery cell positioned at a middle portion in the stacking direction of the plurality of battery cells or in the vicinity of the middle portion is not easily dissipated to the outside. Further, performance degradation tends to be accelerated in a battery cell of which the temperature is increased, and it is possible to prevent performance degradation of a power storage module by uniformly preventing the temperature increase.

An object of an aspect of the present invention is to provide a power storage module capable of improving a heat dissipation performance of a plurality of battery cells that are stacked.

(1) A power storage module according to an aspect of the present invention includes: a plurality of battery cells that are stacked in one direction; and a battery case that houses the plurality of battery cells, wherein the battery case includes: a case main body which is formed in a tubular shape having an axial direction that is a first orthogonal direction orthogonal to a stacking direction of the plurality of battery cells, and of which an inside is a housing space that houses the plurality of battery cells; and a plurality of partition walls which are connected to an inner surface of the case main body, which are arranged to be spaced from each other in the stacking direction, and which partition the housing space into a plurality of division spaces that are arranged in the stacking direction, and lengths of the division spaces in the stacking direction become smaller toward a middle from an end of the housing space in the stacking direction.

(2) In the power storage module, the case main body may be formed in a rectangular tubular shape having a pair of first side walls that are arranged to be spaced from each other in the stacking direction and a pair of second side walls that are arranged to be spaced from each other in a second orthogonal direction which is orthogonal to the stacking direction and the first orthogonal direction, each of the partition walls may be formed to extend in the second orthogonal direction, and each of both ends of each of the partition walls in the second orthogonal direction may be connected to each of the pair of second side walls.

(3) In the power storage module, an outer surface of the first side wall that faces an outside of the case main body in the stacking direction may be formed to be inclined so as to face further outside of the case main body in the stacking direction toward a middle from both ends of the first side wall in the second orthogonal direction, and an inner surface of the first side wall that faces an inside of the case main body in the stacking direction may be formed in a flat surface that is orthogonal to the stacking direction.

(4) In the power storage module, a protrusion part that protrudes from an outer surface of the second side wall which faces an outside of the case main body may be formed on the second side wall, and the protrusion part may overlap the partition wall in the second orthogonal direction.

(5) In the power storage module, the protrusion part may be a boss part having a tubular shape that extends in the first orthogonal direction.

According to the above aspect (1), the length of the division space that is positioned at the middle of the housing space in the stacking direction is smaller than the length of the division space that is positioned at the end of the housing space. That is, a plurality of partition walls are arranged densely at the middle portion of the housing space. Thereby, heat generated in the battery cell housed in the middle portion of the housing space can be efficiently transmitted to the partition wall and can be further transmitted from the partition wall to the case main body efficiently. Thereby, the heat of the battery cell that is positioned at the middle portion can be effectively dissipated outside the case main body. Accordingly, it is possible to improve the heat dissipation performance of the plurality of battery cells that are stacked.

According to the above aspect (2), a plurality of partition walls that connect between a pair of second side walls of the case main body are arranged densely at the middle portion of the housing space. That is, the spacing between the partition walls at the middle portion is small. Therefore, even when an external force such as an impact or a load acts on one of the second side walls from the outside of the case main body, it is possible to prevent the one of the second side walls from being deformed (in particular, from being flexurally deformed). Accordingly, it is possible to improve the strength and rigidity of the pair of second side walls. In particular, it is possible to improve the strength and rigidity of the middle portion of each of the second side walls in the stacking direction.

According to the above aspect (3), the thickness of the first side wall in the stacking direction is increased toward the middle from both ends of the first side wall in the second orthogonal direction. Therefore, even when an external force such as an impact or a load acts on the first side wall from the outside of the case main body, it is possible to prevent the first side wall from being deformed (in particular, from being flexurally deformed).

Further, according to the above aspect (3), even when the first side wall is pushed from the inside of the case main body by an expansion force of the battery cell in association with charging and discharging, heat generation, or degradation, it is possible to prevent the first side wall from being deformed (in particular, from being flexurally deformed).

Further, according to the above aspect (3), since the thickness of the first side wall in the stacking direction is thin at both end parts of the first side wall in the second orthogonal direction, it is possible to reduce a material that is used for the first side wall while preventing deformation of the first side wall. Thereby, it is possible to achieve weight saving of the power storage module that includes the first side wall and reduce manufacturing costs.

According to the above aspect (4), by providing the protrusion part at a position that overlaps the partition wall, heat generated in the battery cell can be efficiently transmitted from the partition wall to the protrusion part. Since the protrusion part protrudes from the outer surface of the second side wall, the heat transmitted to the protrusion part can be effectively dissipated outside the case main body.

Further, according to the above aspect (4), when the second side wall hits an object (for example, the ground), prior to the second side wall, the protrusion part comes into contact with the object. That is, it is possible to avoid the second side wall directly hitting the object. Further, the protrusion part overlaps the partition wall, and thereby, an external force such as an impact or a load that acts on the protrusion part can be directly transmitted to the partition wall. That is, it is possible to prevent the external force that acts on the protrusion part from being transmitted to the second side wall. Therefore, it is possible to prevent the second side wall from being deformed by the external force.

According to the above aspect (5), a screw is inserted in the boss part, and thereby, it is possible to fix a component (for example, a lid part that covers an opening of the case main body) to the case main body. Accordingly, the boss part for fixing the component to the case main body can be used effectively for heat dissipation of the battery cell and prevention of deformation of the second side wall.

Further, according to the above aspect (5), the boss part in which the screw is inserted for fixing the component to the case main body protrudes from the outer surface of the case main body. Therefore, it is possible to make the thickness of the second side wall small while ensuring the rigidity of the second side wall in comparison with a case where a hole in which a screw is inserted is formed on the second side wall. Thereby, it is possible to reduce a material that is used for the second side wall. Accordingly, it is possible to achieve weight saving of the power storage module that includes the second side wall and reduce manufacturing costs.

### BRIEF DESCRIPTION OF THE DRAWINGS

FIG. 1 is a perspective view of a power storage module when seen from a first lid part side according to an embodiment of the present invention.

FIG. 2 is a perspective view of the power storage module when seen from a second lid part side according to the embodiment.

FIG. 3 is an exploded perspective view showing a state in which a pair of lid parts are separated from a case main body in the power storage module according to the embodiment.

FIG. 4 is an exploded perspective view showing a state in which a plurality of battery cells are taken out from the case main body in the power storage module according to the embodiment.

FIG. 5 is a plan view of the case main body when seen from an axial direction of the case main body in the power storage module according to the embodiment.

FIG. 6 is a cross-sectional view taken along a VI-VI line of FIG. 5.

### DESCRIPTION OF EMBODIMENTS

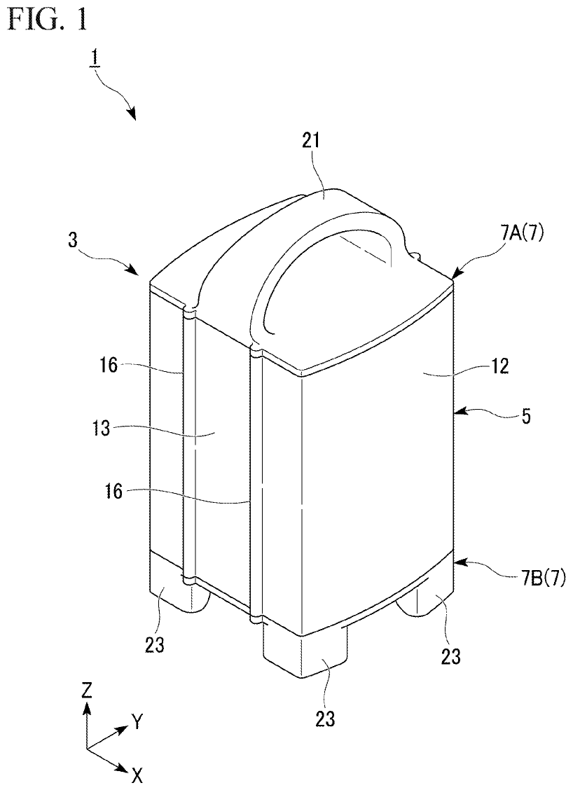

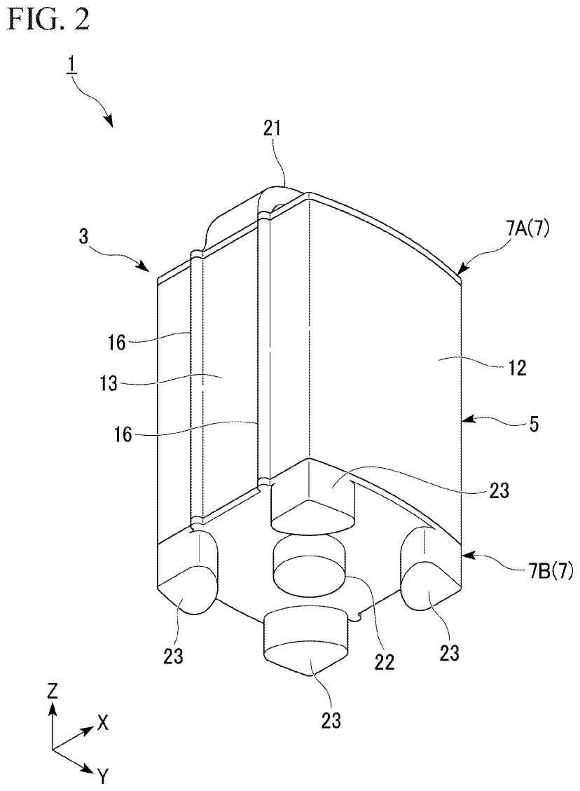

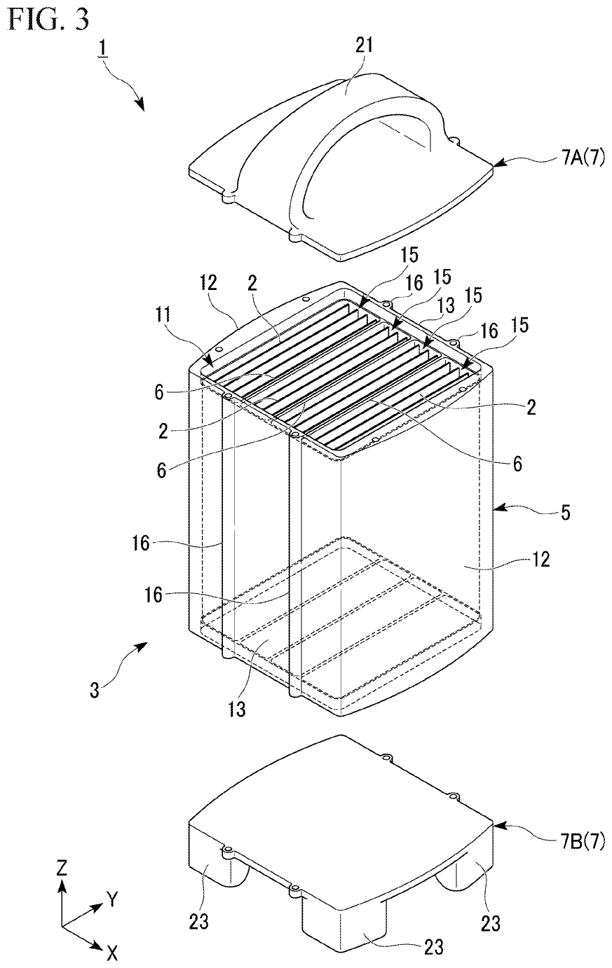

Hereinafter, an embodiment of the present invention will be described with reference to FIGS. 1 to 6.

As shown in FIGS. 1 to 3, a power storage module 1 according to the present embodiment includes a plurality of battery cells 2 that are stacked in one direction and a battery case 3 that houses the plurality of battery cells 2.

In FIGS. 1 to 6, a X-axis direction indicates a stacking direction of the plurality of battery cells 2, a Z-axis direction indicates a first orthogonal direction that is orthogonal to the stacking direction, and a Y-axis direction indicates a second orthogonal direction that is orthogonal to the stacking direction and the first orthogonal direction.

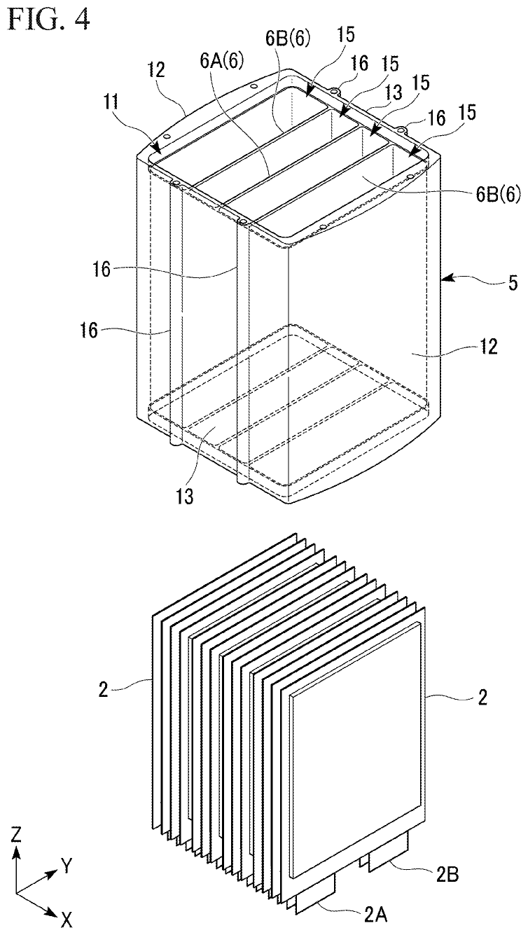

A shape of the battery cell 2 may be arbitrary. As shown in FIGS. 4 to 6, the battery cell 2 of the present embodiment is formed in a plate shape having the stacking direction (X-axis direction) as a thickness direction. Specifically, the battery cell 2 is a laminate-type battery cell 2 in which a pair of films are laminated as battery elements. The laminate-type battery cell 2 may expand in the thickness direction (stacking direction) at the time of charging and discharging, at the time of heat generation, or at the time of performance degradation.

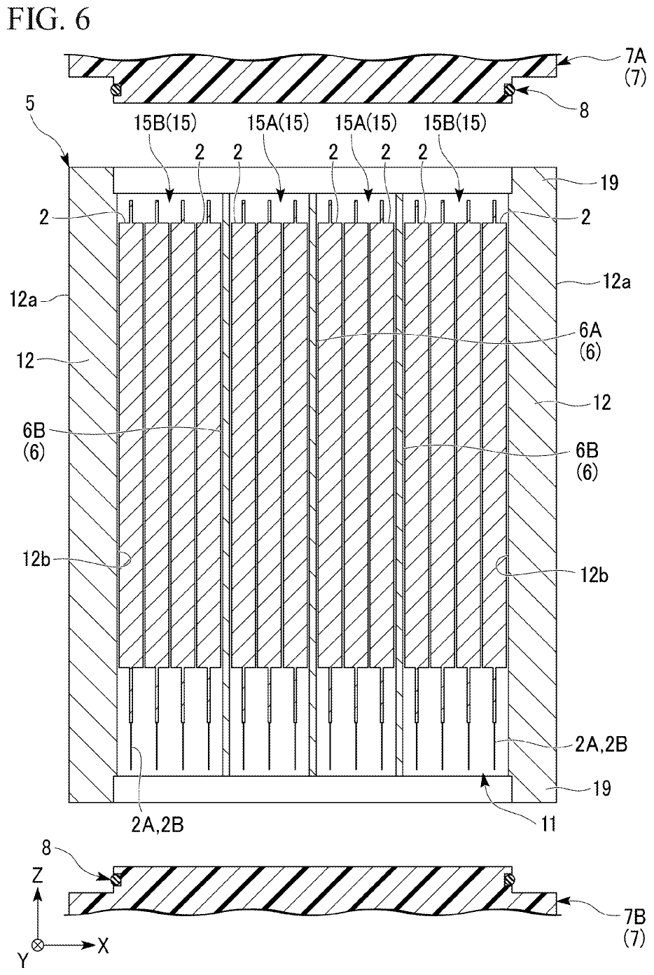

As shown in FIGS. 4 and 6, the plurality of battery cells 2 are stacked such that electrodes 2A, 2B of each battery cell 2 are positioned on one side (a negative direction side of the Z-axis) in the first orthogonal direction. The plurality of battery cells 2 are electrically connected in series or in parallel by appropriately connecting the electrodes 2A, 2B using a circuit board or a bus bar (not shown).

As shown in FIGS. 1 to 6, the battery case 3 includes a case main body 5 and a plurality of partition walls 6. The battery case 3 further includes a pair of lid parts 7.

As shown in FIGS. 4 to 6, the case main body 5 is formed in a tubular shape having an axial direction which is the first orthogonal direction (Z-axis direction). An inside of the case main body 5 is a housing space 11 that houses the plurality of battery cells 2. The plurality of battery cells 2 are arranged in the housing space 11 in a state of being arranged in a direction that is orthogonal to the axial direction of the case main body 5.

The case main body 5 may be formed, for example, in an arbitrary tubular shape such as a cylindrical shape. The case main body 5 of the present embodiment is formed in a rectangular tubular shape having a pair of first side walls 12 and a pair of second side walls 13.

The pair of first side walls 12 are arranged to be spaced from each other in the stacking direction (X-axis direction) of the plurality of battery cells 2. That is, each of the pair of first side walls 12 is positioned on each of both sides of the plurality of battery cells 2 that are housed in the housing space 11 in the stacking direction. The pair of second side walls 13 are arranged to be spaced from each other in the second orthogonal direction (Y-axis direction).

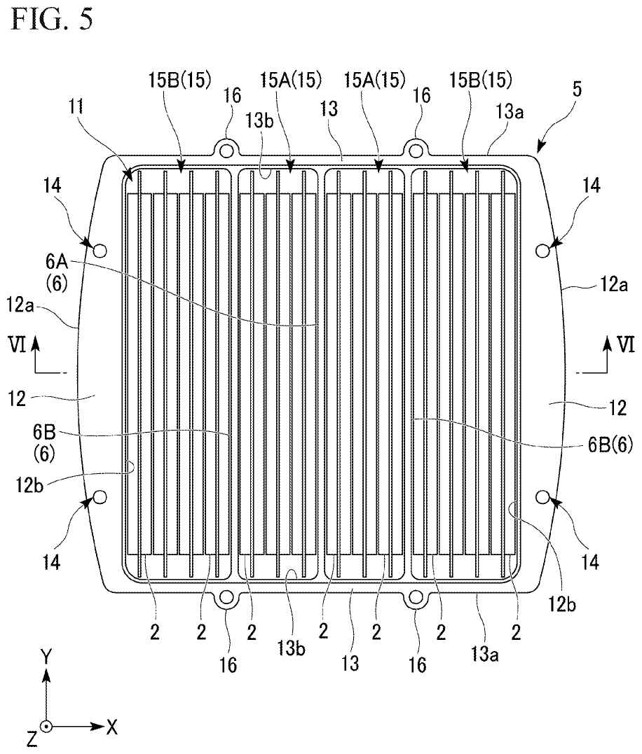

As shown in FIGS. 4 and 5, the first side wall 12 extends in the first and second orthogonal directions and is formed in a plate shape having a thickness direction which is the stacking direction. The first side wall 12 may be formed, for example, in a flat plate shape. The first side wall 12 of the present embodiment is formed to expand to the outside of the case main body 5.

As shown in FIG. 5, an outer surface 12a of the first side wall 12 that faces the outside of the case main body 5 in the stacking direction is formed to be inclined so as to face further outside of the case main body 5 in the stacking direction toward a middle from both ends of the first side wall 12 in the second orthogonal direction. Specifically, the outer surface 12a of the first side wall 12 is formed in an arc shape in which the middle of the outer surface 12a in the second orthogonal direction protrudes to further outside of the case main body 5 in the stacking direction than both ends of the outer surface 12a. On the other hand, an inner surface 12b of the first side wall 12 that faces the inside of the case main body 5 in the stacking direction is formed to be a flat surface that is orthogonal to the stacking direction. Thereby, a thickness of the first side wall 12 in the stacking direction is increased toward the middle from both ends of the first side wall 12 in the second orthogonal direction.

A through hole 14 that penetrates in the first orthogonal direction is formed on each of the first side walls 12. A plurality of (two in an example shown in the drawings) through holes 14 are arranged to be spaced from each other in the second orthogonal direction in each of the first side walls 12. A screw (not shown) for fixing the lid part 7 (component), which will be described later, to the case main body 5 passes through the through hole 14. For example, a female screw that is engaged with the screw may be formed on an inner circumference of the through hole 14.

The through hole 14 may be formed in a region excluding both ends of the first side wall 12 having a small thickness compared to another part of the first side wall 12. Thereby, it is possible to prevent a decrease in rigidity of the first side wall 12 in association with formation of the through hole 14.

As shown in FIGS. 4 and 5, each of the second side walls 13 is formed in a plate shape that extends in the stacking direction and the first orthogonal direction and that has a thickness direction which is the second orthogonal direction. The second side wall 13 of the present embodiment is formed in a flat plate shape. That is, each of an outer surface 13a of the second side wall 13 that faces the outside of the case main body 5 and an inner surface 13b of the second side wall 13 that faces the inside of the case main body 5 is orthogonal to the second orthogonal direction.

For example, the pair of first side walls 12 and the pair of second side walls 13 described above may be formed separately and then fixed to each other. In the present embodiment, the pair of first side walls 12 and the pair of second side walls 13 are integrally formed.

As shown in FIGS. 4 to 6, the plurality of partition walls 6 are connected to an inner surface of the case main body 5 and are arranged to be spaced from each other in the stacking direction (X-axis direction). A plurality of partition walls 6 partition the housing space 11 of the case main body 5 into a plurality of division spaces 15 that are arranged in the stacking direction. According to the arrangement of the plurality of partition walls 6, the lengths of the division spaces 15 in the stacking direction become smaller toward a middle from an end of the housing space 11 in the stacking direction. That is, the plurality of partition walls 6 are arranged such that the length of the division space 15 that is positioned at the middle of the housing space 11 is smaller than the division space 15 that is positioned at the end of the housing space 11.

Thereby, the number of battery cells 2 that are housed in the division space 15 which is positioned at the middle (or near the middle) of the housing space 11 is smaller than the number of battery cells 2 that are housed in the division space 15 which is positioned at the end (or near the end) of the housing space 11.

The number of partition walls 6 in the present embodiment is three. Thereby, the number of division spaces 15 is four.

The three partition walls 6 include one first partition wall 6A that is arranged on the middle of the housing space 11 in the stacking direction and two second partition walls 6B each of which is arranged on each of both sides of the first partition wall 6A. As shown in FIGS. 5 and 6, the spacing between the first partition wall 6A and each of the second partition walls 6B is smaller than the spacing between each of the second partition walls 6B and the inner surface 12b of the first side wall 12 that defines an end of the housing space 11. Thereby, among four division spaces 15, the length of two first division spaces 15A that are positioned at the middle of the housing space 11 in the stacking direction is smaller than the length of two second division spaces 15 each of which is positioned at each of both ends of the housing space 11. The lengths of the two first division spaces 15A may be, for example, different from each other but are equal to each other in the present embodiment. Similarly, the lengths of the two second division spaces 15B may be, for example, different from each other but are equal to each other in the present embodiment.

In the example shown in the drawings, three battery cells 2 are housed in each of the first division spaces 15A, and four battery cells 2 are housed in each of the second division spaces 15B; however, the embodiment is not limited thereto.

As shown in FIGS. 4 to 6, the partition wall 6 of the present embodiment extends in the first orthogonal direction and the second orthogonal direction and is formed in a flat plate shape having a plate thickness direction which is the stacking direction. Each of both ends of each of the partition walls 6 in the second orthogonal direction is connected to each of the pair of second side walls 13.

For example, the partition wall 6 may be formed separately from the case main body 5 and then attached to the case main body 5. The partition wall 6 of the present embodiment is formed integrally with the case main body 5.

As shown in FIGS. 4 and 5, a protrusion part 16 that protrudes from the outer surface 13a of the second side wall 13 is formed on each of the second side walls 13 of the case main body 5.

The shape and arrangement of the protrusion part 16 may be arbitrary. In the present embodiment, the protrusion part 16 extends straight from one end to another end of the second side wall 13 in the first orthogonal direction. Further, a plurality of (two in the example shown in the drawings) protrusion parts 16 are arranged to be spaced from each other in the stacking direction. Each of the protrusion parts 16 is positioned at further inside of the case main body 5 than the inner surface 12b of the pair of first side walls 12 in the stacking direction.

Further, the protrusion part 16 overlaps the partition wall 6 in the second orthogonal direction (thickness direction of the second side wall 13). The protrusion part 16 may be arranged to partially or entirely overlap the partition wall 6. In the example shown in the drawings, the middle of the protrusion part 16 in the stacking direction is deviated in the stacking direction from the middle of the partition wall 6 in the stacking direction; however, the embodiment is not limited thereto. Further, in the example shown in the drawings, the protrusion part 16 is arranged to overlap the second partition wall 6B but, for example, may be arranged to overlap the first partition wall 6A.

The protrusion part 16 of the present embodiment is a boss part 16 having a tubular shape that extends in the first orthogonal direction. A screw (not shown) for fixing the lid part 7, which will be described later, to the case main body 5 is inserted in the boss part 16. For example, a female screw that is engaged with the screw may be formed on an inner circumference of the boss part 16.

The case main body 5 and the partition wall 6 described above may be formed of a material having a high thermal conductivity such as aluminum. The case main body 5 and the partition wall 6 can be manufactured by extrusion molding.

As shown in FIGS. 1 to 3, the pair of lid parts 7 cover openings at both ends of the case main body 5 in the first orthogonal direction (axial direction of the case main body 5). Each of the pair of lid parts 7 is provided attachably to and detachably from the case main body 5 by screwing or the like. Each of the lid parts 7 is formed in a rectangular shape that corresponds to the case main body 5 when seen from the first orthogonal direction.

A grip part 21 for carrying the power storage module 1 is provided on a first lid part 7A of the pair of lid parts 7. The grip part 21 is formed in a curved bar shape or a band plate shape. Both ends of the grip part 21 are connected to an outer surface of the first lid part 7A that faces to the outside of the case main body 5. The power storage module 1 includes the grip part 21, and thereby, the power storage module 1 can be used as a portable power storage module.

In the present embodiment, the first lid part 7A that includes the grip part 21 is constituted of a resin having a lower thermal conductivity than that of the case main body 5.

A connector 22 and a plurality of leg parts 23 are provided on a second lid part 7B of the pair of lid parts 7.

The connector 22 electrically connects the power storage module 1 (the plurality of battery cells 2) to an external apparatus. The connector 22 protrudes from an outer surface of the second lid part 7B that faces to the outside of the case main body 5. The connector 22 is formed in a cylindrical shape and is arranged at a position centered on the axis line of the case main body 5. That is, the connector 22 is formed in an axially symmetric shape and is arranged at a position that is axially symmetric with respect to the case main body 5.

The plurality of leg parts 23 protrude from the outer surface of the second lid part 7B in the same manner as the connector 22. A protrusion height of the leg part 23 with respect to the outer surface of the second lid part 7B is greater than a protrusion height of the connector 22. The plurality of leg parts 23 are arranged to surround the connector 22. Specifically, the plurality of leg parts 23 are arranged at four corners of the outer surface of the second lid part 7B that is formed in a rectangular shape. By providing the plurality of leg parts 23, it is possible to prevent the connector 22 from coming into contact with the ground or the like in a state where the power storage module 1 is placed on the ground or the like such that the second lid part 7B is arranged on a lower side in a vertical direction.

In the present embodiment, similarly to the first lid part 7A, the second lid part 7B that includes the leg part 23 is constituted of a resin having a lower thermal conductivity than that of the case main body 5.

As shown in FIG. 6, the battery case 3 of the present embodiment further includes a seal part 8 that fills a gap between the lid part 7 and an opening end part 19 of the case main body 5. The seal part 8 prevents moisture from entering the inside of the case main body 5 from the gap between the lid part 7 and the case main body 5.

The seal part 8 in the example shown in the drawings is a shaft seal that is provided between an inner circumference of the case main body 5 at the opening end part 19 and an outer circumference of an insertion part of the lid part 7 that is inserted in the inside of the opening end part 19 of the case main body 5. The seal part 8 may be, for example, a flat seal that is provided between an end surface of the case main body 5 that faces the outside of the case main body 5 in the first orthogonal direction and an opposing surface of the lid part 7 that faces the end surface.

As described above, according to the power storage module 1 of the present embodiment, the housing space 11 of the case main body 5 is partitioned into the plurality of division spaces 15 by the plurality of partition walls 6. Further, the lengths of the division spaces 15 become smaller toward the middle from the end of the housing space 11 in the stacking direction. That is, the partition walls 6 are arranged densely at the middle portion of the housing space 11. Thereby, heat generated at the battery cell 2 that is housed in the first division space 15A (middle portion of the housing space 11) can be efficiently transmitted to the partition wall 6 and can be further transmitted from the partition wall 6 to the case main body 5 efficiently. Thereby, the heat of the battery cell 2 that is positioned in the first division space 15A can be effectively dissipated to the outside of the case main body 5. Accordingly, it is possible to improve the heat dissipation performance of the plurality of battery cells 2 that are stacked.

The heat of the battery cell 2 that is positioned in the second division space 15B (end of the housing space 11) can be directly transmitted to the case main body 5 and therefore effectively dissipated to the outside of the case main body 5.

Further, in the power storage module 1 of the present embodiment, mainly, the heat of the battery cell 2 that is positioned in the first division space 15A is transmitted to the second side wall 13 of the case main body 5, and the heat of the battery cell 2 that is positioned in the second division space 15B is transmitted to the first side wall 12 of the case main body 5. That is, the heat of the battery cell 2 that is positioned in the first division space 15A and the heat of the battery cell 2 that is positioned in the second division space 15B can be transmitted to different regions from each other of the case main body 5. Accordingly, it is possible to effectively improve the heat dissipation performance of the plurality of battery cells 2 that are stacked.

Further, according to the power storage module 1 of the present embodiment, the partition walls 6 that connect between the pair of second side walls 13 of the case main body 5 are arranged densely at the middle portion of the housing space 11. That is, the spacing between the partition walls 6 at the middle portion is small. Therefore, even when an external force such as an impact or a load acts on one of the second side walls 13 from the outside of the case main body 5, it is possible to prevent the one of the second side walls 13 from being deformed (in particular, from being flexurally deformed). Specifically, when an external force such as an impact acts on one of the second side walls 13 from the outside of the case main body 5, the external force is transmitted to another of the second side walls 13 via the partition wall 6, and thereby, it is possible to prevent deformation (in particular, flexural deformation) of the one of the second side walls 13. Accordingly, it is possible to improve the strength and rigidity of the pair of second side walls 13. Specifically, it is possible to improve the strength and rigidity of the middle portion of each of the second side walls 13 in the stacking direction. The ability of preventing the deformation of the second side wall 13 is effective in that it is possible to prevent occurrence of a problem in a function (charging and discharging) of the power storage module 1 due to the battery cell 2 deforming or moving in the case main body 5 in accordance with the deformation of the second side wall 13.

Further, according to the power storage module 1 of the present embodiment, the thickness of the first side wall 12 in the stacking direction is increased toward the middle from both ends of the first side wall 12 in the second orthogonal direction.

Therefore, even when an external force such as an impact or a load acts on the first side wall 12 from the outside of the case main body 5, it is possible to prevent the first side wall 12 from being deformed (in particular, from being flexurally deformed). In particular, the outer surface 12a of the first side wall 12 is formed in an arc shape that protrudes to the outside of the case main body 5, and thereby, it is possible to effectively prevent deformation of the first side wall 12 by the external force from the outside of the case main body 5.

Further, even if the first side wall 12 is pushed from the inside of the case main body 5 by an expansion force of the battery cell 2 in association with charging and discharging, heat generation, or performance degradation, it is also possible to prevent deformation (in particular, flexural deformation) of the first side wall 12. Specifically, when a force from the inside of the case main body 5 acts on the first side wall 12, a bending moment in the first side wall 12 is maximized at the middle portion of the first side wall 12 in the second orthogonal direction. On the other hand, in the power storage module 1 of the present embodiment, by forming the middle portion of the first side wall 12 in the second orthogonal direction to be thick, a geometrical moment of inertia of the middle portion of the first side wall 12 increases. Thereby, it is possible to effectively prevent deformation (in particular, flexural deformation) of the first side wall 12.

Further, the thickness of the first side wall 12 in the stacking direction is thin at both end parts of the first side wall 12 in the second orthogonal direction, and thereby, it is possible to reduce a material that is used for the first side wall 12 while preventing deformation of the first side wall 12. Thereby, it is possible to achieve weight saving of the power storage module 1 that includes the first side wall 12 and reduce manufacturing costs.

Further, according to the power storage module 1 of the present embodiment, the protrusion part 16 that is formed on the outer surface 13a of the second side wall 13 overlaps the partition wall 6 in the second orthogonal direction (thickness direction of the second side wall 13).

Thereby, heat generated in the battery cell 2 can be efficiently transmitted from the partition wall 6 to the protrusion part 16. Since the protrusion part 16 protrudes from the outer surface 13a of the second side wall 13, the heat that is transmitted to the protrusion part 16 can be effectively dissipated to the outside of the case main body 5.

Further, the protrusion part 16 protrudes from the outer surface 13a of the second side wall 13, and thereby, when the second side wall 13 hits an object (for example, the ground), prior to the second side wall 13, the protrusion part 16 comes into contact with the object. That is, it is possible to avoid the second side wall 13 directly hitting the object. Further, the protrusion part 16 overlaps the partition wall 6, and thereby, an external force such as an impact or a load that acts on the protrusion part 16 can be directly transmitted to the partition wall 6. That is, it is possible to prevent the external force that acts on the protrusion part 16 from being transmitted to the second side wall 13. Therefore, it is possible to prevent the second side wall 13 from being deformed by the external force.

Further, according to the power storage module 1 of the present embodiment, the protrusion part 16 is a boss part 16 having a tubular shape. Therefore, a screw is inserted in the boss part 16, and thereby, it is possible to fix the lid part 7 (component) to the case main body 5. Accordingly, the boss part 16 for fixing the lid part 7 to the case main body 5 can be used effectively for heat dissipation of the battery cell 2 and prevention of deformation of the second side wall 13.

Further, the boss part 16 in which the screw is inserted for fixing the lid part 7 to the case main body 5 protrudes from the outer surface of the case main body 5. Therefore, it is possible to make the thickness of the second side wall 13 small while ensuring the rigidity of the second side wall 13 in comparison with a case where a hole in which a screw is inserted is formed on the second side wall 13. Thereby, it is possible to reduce a material that is used for the second side wall 13. Accordingly, it is possible to achieve weight saving of the power storage module 1 that includes the second side wall 13 and reduce manufacturing costs.

Further, according to the power storage module 1 of the present embodiment, the four wall parts (the pair of first side walls 12 and the pair of second side walls 13) that constitute the case main body 5 are integrally formed. In this configuration, since there is no seam at boundaries between the four wall parts, it is possible to reduce locations through which moisture enters the inside of the case main body 5. That is, it is possible to reduce the number of seal parts that close the seam in order to prevent moisture from entering the inside of the case main body 5 and simplify a seal structure of the battery case 3.

Further, according to the power storage module 1 of the present embodiment, the rigidity of the case main body 5 can be improved by integrally forming the four wall parts that constitute the case main body 5. Thereby, it is possible to prevent deformation of these wall parts even when an external force such as an impact or a load acts on the wall part of the case main body 5 from the outside of the case main body 5, or the wall part of the case main body 5 is pushed from the inside of the case main body 5 in association with the expansion of the battery cell 2. In particular, it is possible to effectively prevent occurrence of a gap between the case main body 5 and the lid part 7 (occurrence of a state in which the seal part 8 does not function) in association with deformation of the opening end part 19 of the case main body 5. That is, it is possible to effectively prevent the sealing performance of the battery case 3 from being impaired.

Further, according to the power storage module 1 of the present embodiment, a structure such as the leg part 23 and the grip part 21 formed of a resin are provided on the lid part 7. Thereby, since the structure made of a resin is not provided on the outer surface of the case main body 5, it is possible to prevent the heat dissipation performance of the battery cell 2 from being degraded due to the structure.

Although the details of the embodiment of the present invention have been described above, the present invention is not limited to the embodiment described above, and various modifications can be made without departing from the scope of the present invention.

In the power storage module according to the embodiment of the present invention, the number of partition walls 6 may be, for example, two, or equal to or greater than four. When the number of partition walls 6 is two, the number of division spaces 15 is three, and according to the arrangement of the two partition walls 6, the length of one division space 15 that is positioned at the middle of the housing space 11 is smaller than the lengths of two division spaces 15 that are positioned at both ends of the housing space 11. For example, among the three division spaces 15, two battery cells 2 may be housed in the one division space 15 at the middle, and five battery cells 2 may be housed in the two division spaces 15 at both ends.

What is claimed is:

1. A power storage module comprising:
a plurality of battery cells that are stacked in one direction; and
a battery case that houses the plurality of battery cells,
wherein the battery case comprises: a case main body which is formed in a tubular shape having an axial direction that is a first orthogonal direction orthogonal to a stacking direction of the plurality of battery cells, and of which an inside is a housing space that houses the plurality of battery cells; and a plurality of partition walls which are connected to an inner surface of the case main body, which are arranged to be spaced from each other in the stacking direction, and which partition the housing space into a plurality of division spaces that are arranged in the stacking direction, and
lengths of the division spaces in the stacking direction become smaller toward a middle from an end of the housing space in the stacking direction.

2. The power storage module according to claim 1,
wherein the case main body is formed in a rectangular tubular shape having a pair of first side walls that are arranged to be spaced from each other in the stacking direction and a pair of second side walls that are arranged to be spaced from each other in a second orthogonal direction which is orthogonal to the stacking direction and the first orthogonal direction,
each of the partition walls is formed to extend in the second orthogonal direction, and
each of both ends of each of the partition walls in the second orthogonal direction is connected to each of the pair of second side walls.

3. The power storage module according to claim 2,
wherein an outer surface of the first side wall that faces an outside of the case main body in the stacking direction is formed to be inclined so as to face further outside of the case main body in the stacking direction toward a middle from both ends of the first side wall in the second orthogonal direction, and
an inner surface of the first side wall that faces an inside of the case main body in the stacking direction is formed in a flat surface that is orthogonal to the stacking direction.

4. The power storage module according to claim 2,
wherein a protrusion part that protrudes from an outer surface of the second side wall which faces an outside of the case main body is formed on the second side wall, and
the protrusion part overlaps the partition wall in the second orthogonal direction.

5. The power storage module according to claim 4,
wherein the protrusion part is a boss part having a tubular shape that extends in the first orthogonal direction.

6. The power storage module according to claim 3,
wherein a protrusion part that protrudes from an outer surface of the second side wall which faces an outside of the case main body is formed on the second side wall, and
the protrusion part overlaps the partition wall in the second orthogonal direction.

7. The power storage module according to claim 6,
wherein the protrusion part is a boss part having a tubular shape that extends in the first orthogonal direction.
